(19) United States
(12) Patent Application Publication
(10) Pub. No.: US 2011/0031819 A1
(43) Pub. Date: Feb. 10, 2011

(54) Electrical timer apparatus and a system for disconnecting electrical power

(76) Inventor: Keven Gunwall, Crystal Lake, IL (US)

Correspondence Address: SCHERRER PATENT & TRADEMARK LAW P.C., 17 E. CRYSTAL LAKE AVE, CRYSTAL LAKE, IL, 60014, US

(21) Appl. No.: 12/462,507

(22) Filed: Aug. 5, 2009

(51) Int. Cl. H01H 43/04

(52) U.S. Cl. 307/141.4

(57) ABSTRACT

An apparatus and system disconnects electrical power from an electrical power outlet. Specifically, the apparatus and system disconnects electrical power, such as AC power, from an electrical receptacle and a timer when the timer has expired. More specifically, the apparatus and system for disconnecting electrical power has a plurality of switches to engage a timer circuit. A first switch either engages the timer circuit or bypasses the timer circuit. Upon engaging the timer circuit, a second switch is engaged to supply power to the timer circuit for the duration of a timer. A third switch allows a user to select various timer values to set the duration of the timer. One or more indicators informs a user whether the bypass circuit is engaged or whether the timer circuit is engaged.

### BACKGROUND OF THE INVENTION

The present invention generally relates to an electrical timer apparatus and a system for disconnecting electrical power. Specifically, the present invention relates to an apparatus and system for disconnecting electrical power, such as AC power, when a timer has expired. More specifically, the present invention relates to an apparatus and system for disconnecting electrical power having a plurality of switches to engage a timer circuit. A first switch either engages the timer circuit or bypasses the timer circuit. Upon engaging the timer circuit, a second switch is engaged to supply power to the timer circuit for the duration of a timer. A third switch allows a user to select various timer values to set the duration of the timer. An indicator or a plurality of indicators informs a user whether the bypass circuit is engaged or whether the timer circuit is engaged.

It is, of course, generally known to provide an outlet for powering devices, such as appliances, lighting systems, machines, electronic equipment and other like devices to power the devices. Typically, a wall outlet supplies AC power from a commercial power supply to devices requiring electricity for proper functionality. The wall outlet, otherwise known as a wall socket, power point, power socket, electric receptacle, or electrical outlet are generally female electrical connectors that have slots or holes that accept and deliver current to the prongs of inserted plugs.

The first electrical power outlets were created for lighting systems. Due to a unique tariff system at the time, the cost for electricity for lighting was less than for other uses. This caused a proliferation of devices, such as portable appliances and the like, to be developed to connect to the lighting fittings. Standards developed over the ensuing years, and the modern wall outlet stems from this historical development.

A modern wall outlet generally has two or three wired contacts. The contacts may be steel or brass, and may be plated with zinc, tin, or nickel. The first contact, called the live wire (also known as phase, line, hot or active contact), carries alternating current from the source to the load.

The second contact is the neutral wire (also known as return), which completes the circuit back to the power source. With alternating current there is electrically no difference between the live and neutral, since current alternately flows in both directions. It is so named because the neutral is connected to grounding rods, which serve to dissipate static electricity charge buildups that can shock users of the electrical devices, and so is at neutral voltage potential relative to the ground upon which the user stands. The neutral is generally safe to touch, but the hot is not—a person's body is capacitively coupled to the earth ground, even without direct skin to ground contact.

The third contact is the earth wire (also known as ground, safety ground, or safety earth). If present, the earth wire is intended to carry electric current only when the connected equipment develops an insulation fault. It serves as a secondary safety neutral to provide a direct-shorting path to blow fuses or trip circuit breakers, and is generally connected to metal cases and other parts of the equipment which may come into contact with humans.

Electricity use through wall sockets, such as sockets found in homes and buildings across the world, has increased greatly since the first electrical systems were put into place. Specifically, it is estimated that the world consumes over 16,830,000,000 megawatt-hours per year of electricity. The United States leads all countries in power consumption with over 3,816,000,000 megawatt-hours per year, followed by China with 2,859,000,000 megawatt-hours per year and the European Union at 2,820,000,000 megawatt-hours per year.

A large portion of that power consumption is via electrical appliances, lamps, electronic devices and other like devices. Many of these devices are powered for extended periods of time, even when not being used by a user. For example, many times, lights stay on in buildings, rooms, and houses when a person is not in the building, room or house. Although some lights are necessary for safety, in many cases lights are simply left on when a person leaves a room. This causes wasted power consumption. Moreover, many devices are rarely turned off when not in use. In many cases, for example, computers or other electrical devices are left on when not in use.

Many times, individuals intentionally switch devices off when not in use. However, many devices still pull power from an electrical outlet even when switched off. So-called “vampire” devices are devices that either have no on/off switch and are therefore on at all times, or are turned “off” but, in reality, switched to “standby mode.” In either case, the device continues to draw electrical power when not in use.

The wasted standby power of individual household electronic devices is typically very small, but the sum of all such devices becomes significant over the entire planet. Standby power makes up a portion of homes' miscellaneous electric load, which also includes small appliances, security systems, and other small power draws.

As noted, the power consumed by these so-called electricity vampires is generally relatively small. For example, it is estimated that standby power is typically 10 to 15 watts per device, but can occasionally be more. However, the sum of all devices using standby power can be very large. A 2005 study estimates the number of standby appliances in the EU at 3.7 billion. The fact that these devices are typically continuously plugged in, and the number of such devices in the average household means that the energy usage can reach up to 22 percent of all appliance consumption, and around 10 percent of total residential consumption.

A 1998 study estimated that standby power consumption accounted for approximately 5% of total residential electricity consumption in America. It is estimated that the wasted energy by so-called electricity vampires is equivalent to the output of 18 typical power stations. This is not an insignificant amount of power consumed by these devices. With the huge number of devices that modern humans use on a daily basis, it is difficult to power down every device. Moreover, it is difficult for a user to determine whether a device may still draw power even when switched off if the device is still plugged into the wall outlet.

In addition, many electrical devices are plugged directly into a wall socket, whether they continue to draw power from the power source or not. Brownouts and power surges may occur that may cause damage to the electrical devices. For example, AC induction motors and three-phase motors may draw more current to compensate for the drop in voltage during a brownout, which may lead to overheating or damage of the motor. A power surge, or voltage spike, may lead to excessive current, which may lead to damage of electrical devices.

Along with the huge amount of power consumption by so-called electricity vampires, many devices are being utilized excessively by people, contributing to a health decline in humans, as more and more people utilize the devices instead of getting proper exercise. This trend is especially notable in children as more and more children spend inordinate amounts of time in front of television sets, computers, video game consoles and the like.

According to the Kaiser Family Foundation, in a study published in 2005, it is estimated that children aged 8 to 18 spend more time (44.5 hours per week) in front of computer, television, and video game screens than any other activity in their lives except sleeping. According to the American Obesity Association in 2006, approximately 30.3% of children (ages 6 to 11) were overweight and 15.3% were obese. For teens (12 to 19) the rate is almost identical: 33.4% overweight, and 15.5% obese. Further the incidence of Type II diabetes in children, the diabetes linked with obesity, has increased significantly in the past few decades as time spent in front of televisions, computers and video game consoles has increased.

Of course, parents and guardians are ultimately responsible for ensuring that children spend proper time exercising and eating properly. However, as many parents know, it is difficult to maintain the proper balance of screen time and exercise. Many parents lead very busy lives, especially when both parents work and children are watched by babysitters, nannies and the like. It is oftentimes difficult to properly monitor a child and get that child away from the media screens to pursue other activities.

It is, of course, generally known to provide electrical timers that remove power from an electrical device plugged thereinto. However, many of these known timers, especially electrical timers, continually draw power while monitoring whether the electrical outlet should be turned on or off. Therefore, while the timer may effectively cut power to an electrical device, it continues to draw power to keep itself active, thereby becoming a so-called “vampire” electrical device.

A need, therefore, exists for an apparatus and system for providing an electrical power outlet having a timer that disconnects the electrical power after an amount of time has elapsed.

Moreover, a need exists for an apparatus and system for providing an electrical power outlet wherein a user can set the amount of time to elapse before disconnecting the electrical power.

In addition, a need exists for an apparatus and system for providing an electrical power outlet that signals to a user whether the timer circuitry is engaged, or whether bypass circuitry is engaged.

Further, a need exists for an apparatus and system for providing an electrical power outlet having bypass circuitry allowing electrical power to flow continuously without interruption or disconnection.

Still further a need exists for an apparatus and system for providing an electrical power outlet having a plurality of switches for precise engagement of the timer circuitry to disconnect the electrical power after a selectable amount of time has elapsed.

Moreover, a need exists for an apparatus and system for providing an electrical power outlet to supply power to an electrical device.

In addition, a need exists for an apparatus and system for providing an electrical power outlet to supply power to an electrical device and to disconnect power from the electrical device when an amount of time has elapsed.

Further, a need exists for an apparatus and system for providing an electrical power outlet to supply power to an electrical device and to disconnect power from the electrical device when a selectable amount of time has elapsed.

Still further, a need exists for an apparatus and system for providing an electrical power outlet that completely separates an electrical device from a power source to protect the electrical device during brownout and/or power surge conditions.

Moreover, a need exists for an apparatus and system for providing an electrical power outlet that removes power from a timer when the timer has elapsed.

### SUMMARY OF THE INVENTION

The present invention generally relates to an electrical timer apparatus and a system for disconnecting electrical power. Specifically, the present invention relates to an apparatus and system for disconnecting electrical power, such as AC power, from an electrical outlet and a timer when the timer has expired. More specifically, the present invention relates to an apparatus and system for disconnecting electrical power having a plurality of switches to engage a timer circuit. A first switch either engages the timer circuit or bypasses the timer circuit. Upon engaging the timer circuit, a second switch is engaged to supply power to the timer circuit for the duration of a timer. A third switch allows a user to select various timer values to set the duration of the timer. An indicator informs a user whether the bypass circuit is engaged or whether the timer circuit is engaged.

To this end, in an embodiment of the present invention an electrical timer apparatus is provided. The electrical timer apparatus comprises a connector to engage AC power from an AC power source; a female electrical receptacle for engaging a male electrical plug; a timer circuit comprising a timer selector for selecting a timed interval and a momentary switch for completing the timer circuit, wherein the timer circuit provides electrical power to the female electrical receptacle and to the timer circuit when the momentary switch is engaged and further wherein the timer circuit disconnects electrical power from the female electrical receptacle and the timer circuit when the timed interval elapses; a bypass circuit for providing electrical power to the female electrical receptacle when the bypass circuit is completed with the AC power; and a switch to select either the timer circuit or the bypass circuit.

In an embodiment, the timer circuit comprises an electrical timer wherein the electrical timer provides the selectable timed interval.

In an embodiment, the timer circuit comprises a relay for allowing electrical power to flow to the female electrical receptacle and to the timer circuit when the timer circuit is selected via the switch, the timed interval is selected via the timer selector, and the momentary switch is engaged completing the timer circuit and further wherein the relay disconnects the electrical power from the female electrical receptacle and the timer circuit when the timed interval elapses.

In an embodiment, the timer circuit comprises an electrical timer wherein the electrical timer provides the selectable timed interval and further wherein the timer circuit comprises a relay for allowing electrical power to flow to the female electrical receptacle during the timed interval and further wherein the relay disconnects the electrical power from the female electrical receptacle and the timer circuit when the timer elapses.

In an embodiment, the timer selector comprises a plurality of selectable timed intervals.

In an embodiment, the connector to engage AC power from an AC power source is a male electrical plug to engage a female electrical receptacle.

In an embodiment, the electrical timer apparatus of further comprises a remote control apparatus wherein the switch, timer selector and momentary switch are operational remotely from the electrical timer switch apparatus.

In an embodiment, the electrical timer apparatus further comprises an indicator showing when AC power is flowing to the feMale electrical receptacle.

In an embodiment, the electrical timer apparatus further comprises an indicator showing when the bypass circuit is selected via the switch.

In an embodiment, the electrical timer apparatus further comprises a DC power supply for powering the electrical timer circuit when the timer circuit is selected via the switch.

In an alternate embodiment of the present invention, a system is provided for disconnecting electrical power from an AC power source to a device requiring AC power for operation. The system comprises an AC power source; a device requiring AC power; an electrical timer apparatus comprising a connector to engage AC power from an AC power source, a female electrical receptacle for engaging a male electrical plug, a timer circuit comprising a timer selector for selecting a timed interval and a momentary switch for completing the timer circuit, wherein the timer circuit provides electrical power to the female electrical receptacle and to the timer circuit when the momentary switch is engaged and further wherein the timer circuit disconnects electrical power from the female electrical receptacle and the timer circuit when the timed interval elapses, a bypass circuit for providing electrical power to the female electrical receptacle when the bypass circuit is completed with the AC power, and a switch to select either the timer circuit or the bypass circuit, wherein the device is plugged into the female electrical receptacle of the electrical timer apparatus and the electrical timer apparatus is connected to the AC power source.

In an embodiment, the timer circuit comprises an electrical timer wherein the electrical timer provides the selectable timed interval.

In an embodiment, the timer circuit comprises a relay for allowing electrical power to flow to the female electrical receptacle and to the timer circuit when the timer circuit is selected via the switch, the timed interval is selected via the timer selector, and the momentary switch is engaged completing the timer circuit and further wherein the relay disconnects the electrical power from the female electrical receptacle and the timer circuit when the timed interval elapses.

In an embodiment, the timer circuit comprises an electrical timer wherein the electrical timer provides the selectable timed interval and further wherein the timer circuit comprises a relay for allowing electrical power to flow to the female electrical receptacle during the timed interval and further wherein the relay disconnects the electrical power from the female electrical receptacle and the timer circuit when the timer elapses.

In an embodiment, the timer selector comprises a plurality of selectable timed intervals.

In an embodiment, the connector to engage AC power from an AC power source is a male electrical plug to engage a female electrical receptacle.

In an embodiment, the system further comprises a remote control apparatus wherein the switch, timer selector and momentary switch are operational remotely from the electrical timer apparatus.

In an embodiment, the system further comprises an indicator showing when the electrical timer apparatus allows AC power to flow to the female electrical receptacle.

In an embodiment, the system further comprises an indicator showing when the bypass circuit is selected via the switch.

In an embodiment, the system further comprises a DC power supply for powering the electrical timer circuit when the timer circuit is selected via the switch.

It is, therefore, an advantage of the present invention to provide an apparatus and system for providing an electrical power outlet having a timer that disconnects the electrical power after an amount of time has elapsed.

Moreover, it is an advantage of the present invention to provide an apparatus and system for providing an electrical power outlet wherein a user can set the amount of time to elapse before disconnecting the electrical power.

In addition, it is an advantage of the present invention to provide an apparatus and system for providing an electrical power outlet that signals to a user whether the timer circuitry is engaged, or whether bypass circuitry is engaged.

Further, it is an advantage of the present invention to provide an electrical power outlet having bypass circuitry allowing electrical power to flow continuously without interruption or disconnection.

Still further, it is an advantage of the present invention to provide an apparatus and system for providing an electrical power outlet having a plurality of switches for precise engagement of the timer circuitry to disconnect the electrical power after a selectable amount of time has elapsed.

Moreover, it is an advantage of the present invention to provide an apparatus and system for providing an electrical power outlet to supply power to an electrical device.

In addition, it is an advantage of the present invention to provide an apparatus and system for providing an electrical power outlet to supply power to an electrical device and to disconnect power from the electrical device when an amount of time has elapsed.

Further, it is an advantage of the present invention to provide an apparatus and system for providing an electrical power outlet to supply power to an electrical device and to disconnect power from the electrical device when a selectable amount of time has elapsed.

Still further, it is an advantage of the present invention to provide an apparatus and system for providing an electrical power outlet that completely separates an electrical device from a power source to protect the electrical device during brownout and/or power surge conditions.

Moreover, it is an advantage of the present invention to provide an apparatus and system for providing an electrical power outlet that removes power from a timer when the timer has elapsed.

Additional features and advantages of the present invention are described in, and will be apparent from, the detailed description of the presently preferred embodiments and from the drawings.

### BRIEF DESCRIPTION OF THE DRAWINGS

FIG. 1 illustrates a perspective view of an electrical outlet in an embodiment of the present invention.

FIG. 2 illustrates a perspective view of a electrical power strip in an embodiment of the present invention.

FIG. 3 illustrates a circuit diagram for the electrical outlet or the electrical power strip in an embodiment of the present invention.

### DETAILED DESCRIPTION OF THE PRESENTLY PREFERRED EMBODIMENTS

The present invention generally relates to an electrical timer apparatus and a system for disconnecting electrical power. Specifically, the present invention relates to an apparatus and system for disconnecting electrical power, such as AC power, from an electrical outlet and a timer when the timer has expired. More specifically, the present invention relates to an apparatus and system for disconnecting electrical power having a plurality of switches to engage a timer circuit. A first switch either engages the timer circuit or bypasses the timer circuit. Upon engaging the timer circuit, a second switch is engaged to supply power to the timer circuit for the duration of a timer. A third switch allows a user to select various timer values to set the duration of the timer. An indicator informs a user whether the bypass circuit is engaged or whether the timer circuit is engaged.

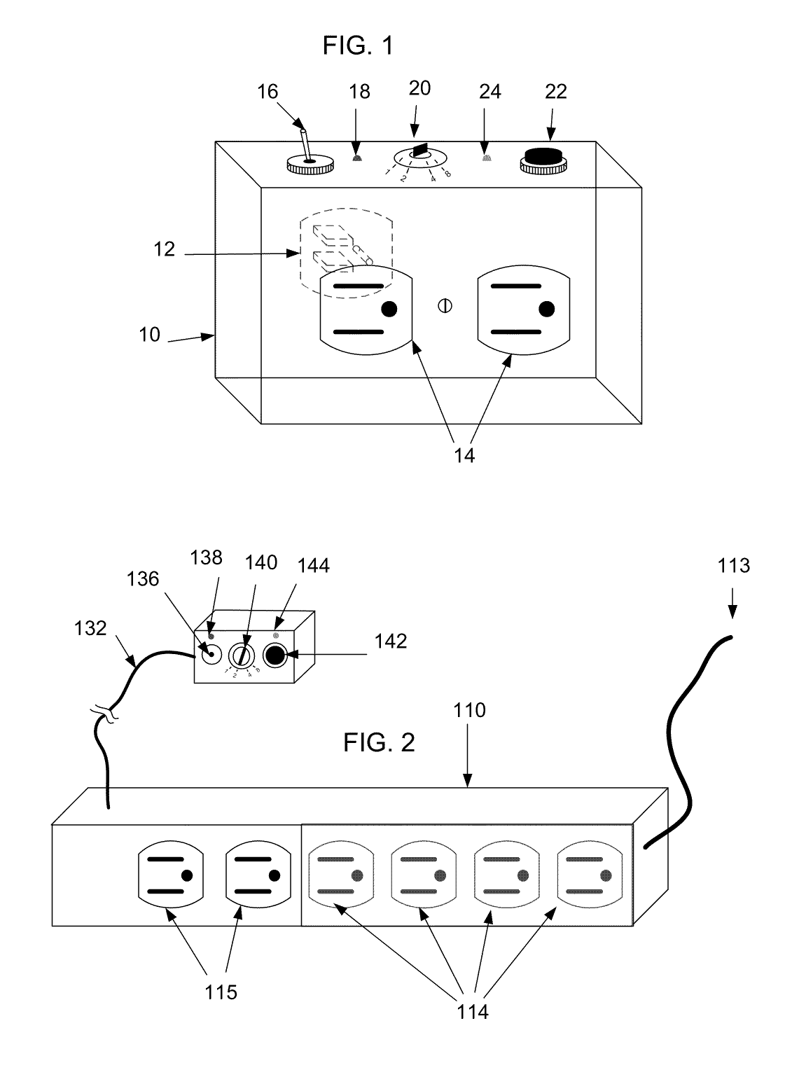

Now referring to the figures, wherein like numerals refer to like parts, FIG. 1 illustrates a perspective view of an electrical outlet apparatus 10 in an embodiment of the present invention. The electrical outlet apparatus 10 may include a male electrical plug 12, shown in phantom on FIG. 1 that may allow the electrical outlet apparatus 10 to plug into, preferably, an electrical wall socket (not shown). It should be noted, however, that the electrical outlet apparatus 10 may be plugged into any female electrical receptacle supplying power to the receptacle, as apparent to one having ordinary skill in the art, and the embodiment should not be limited as described herein. Moreover, although the electrical outlet apparatus 10 is described as having a male electrical plug 12, it should be noted that the electrical outlet apparatus may be directly connected to live, neutral and/or ground leads, directly from the power source without having a male electrical plug 12.

The electrical outlet apparatus 10 may further include one or a plurality of electrical outlets 14 for receiving male electrical plugs from appliances, lamps, electronic equipment and other like devices requiring electricity from a power source for use. The power source may be any AC power source known in the art, such as, for example, standard North American 110V/60 Hz power supplies. However, the present invention may also be used with other AC power supply standards, such as the European 220V/50 Hz power supplies.

The electrical outlet apparatus 10 may allow a user to set a timer whereby electrical power may be completely disconnected from the plurality of electrical outlets 14 and the timer when the timer finishes its countdown or otherwise elapses. Therefore, the timer may draw no electrical power when not engaged during a selected timed interval.

The electrical outlet apparatus 10 may further include a bypass/engage switch 16. Specifically, the bypass/engage switch 16 may allow a user to either bypass the timer within the electrical outlet apparatus 10 or engage the timer.

When the bypass/engage switch is set to “bypass”, a bypass indicator 18 may show that the bypass switch is set to bypass. Specifically, the bypass indicator 18 may preferably be a small light, such as a small LED that indicates the electrical outlet apparatus 10 may be set to bypass. Preferably, the LED may have a color, such as red, to demonstrate that the bypass/engage switch 16 is set to “bypass”. Of course, any other indicator may be provided to demonstrate the bypass/engage switch is set to bypass.

Further, electrical outlet apparatus 10 may include a rotary switch 20 (or multi-switch, or other switch that allows a selection among options, as apparent to one having ordinary skill in the art). Rotary switch 20 may allow a user of the electrical outlet apparatus 10 to select timed intervals. When engaged and operational, the electrical outlet apparatus 10 may provide power to the electrical outlets 14 and to the timer for the duration of the timed interval set by the rotary switch 20. Moreover, when the timer finishes its countdown or otherwise elapses, the electrical outlet apparatus 10 may disconnect power from the electrical outlets, the timer and any other components of the electrical outlet apparatus 10. Although the timed interval may be selected by the rotary switch 20, as described herein, it should be noted that any other mechanism for selecting timed intervals may be utilized, as apparent to one having ordinary skill in the art.

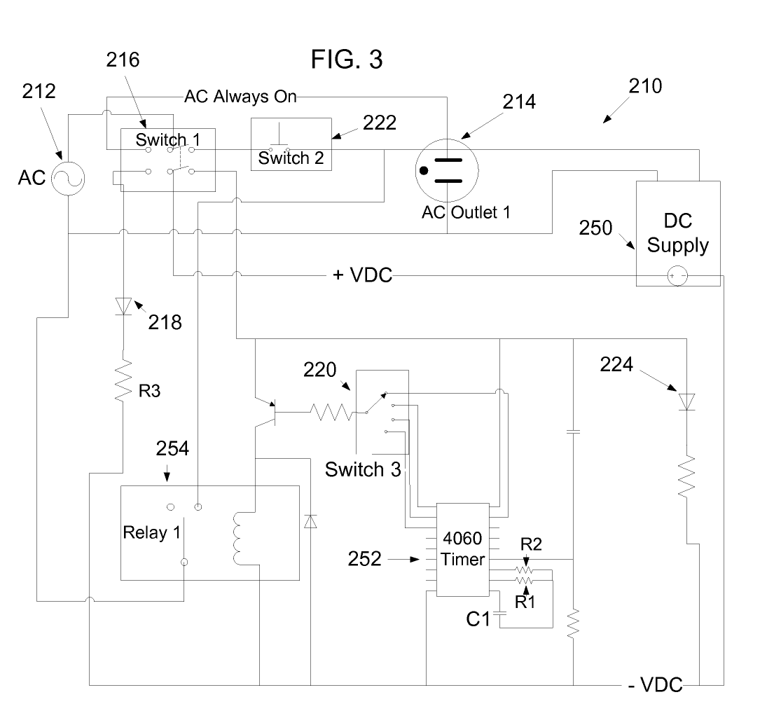

The electrical outlet apparatus 10 may further include a momentary switch 22 for engaging the timer after the bypass/engage switch is toggled to “engage” and after a timed interval is selected using the rotary switch 20. The momentary switch 22 may signal the timer to begin the countdown of the selected timed interval. Specifically, engaging the momentary switch 22 may provide power to the timer within the electrical outlet apparatus 10, as described in more detail below with reference to FIG. 3.

When the bypass/engage switch 16 is toggled to “engage”, a user may select the timed interval via the rotary switch 20, and the momentary switch 22 may engage the timer, an engage indicator 24 may show that the timer is engaged and operational, and actively counting down the selected time interval. Specifically, the engage indicator 24 may preferably be a small light, such as a small LED that indicates the electrical outlet apparatus 10 may be set to engage. Preferably, the LED may have a color, such as green, to demonstrate that the bypass/engage switch 16 may be set to “engage”, the timed interval may have been selected, and the momentary switch may have been engaged. Of course, any other indicator may be provided to demonstrate that the timer is engaged and supplying power to the electrical outlets 14.

When the bypass/engage switch 16 is set to “engage”, the timer interval may be selected via the rotary switch 20, and the momentary switch 22 may be pushed, electrical power may flow freely through the electrical outlets 14, thereby supplying power to devices plugged into one or more of the electrical outlets, and to the timer. When the timer interval counts down to zero, the timer may completely disconnect AC power from the electrical outlets 14, thereby shutting off any devices plugged into the electrical outlets 14. Moreover, when the timer interval counts down to the zero, the timer may completely disconnect AC power to the timer. Of course, when the bypass/engage switch is set to “bypass”, power may freely flow to the electrical outlets 14 to power any devices plugged thereinto.

Now referring to FIG. 2, a power strip 110 is illustrated. The power strip 110 may operate similarly to the electrical outlet apparatus, as described above. For example, the power strip 110 may include a plurality of electrical outlets 114 that are interconnected to a timer. However, the power strip 110 may further include a plurality of powered electrical outlets 115 that may always be active and may continuously supply power to devices plugged thereinto, without regard to the settings of the switches on the power strip 110.

The power strip 110 may further include an extension power cord 113 for plugging the power strip 110 into a wall outlet (not shown) or other AC power supply.

The power strip 110 may include the various switches and control features directly on the power strip 110. However, in a preferred embodiment of the present invention, the various switches engaging the timer function of the power strip 110 may be provided on a remote control apparatus 130 interconnected to the main body of the power strip 110 via an electrical cord 132. It should be noted that although the present invention is described with respect to interconnecting the remote control apparatus 130 to the power strip 110 via the electrical cord 132, it is also contemplated that a wireless remote control apparatus may be used instead, as apparent to one having ordinary skill in the art. It is further contemplated that the electrical outlet apparatus 10, as illustrated in FIG. 1, may also include a wired or wireless remote control apparatus interconnected thereto for control of the timer functions of the electrical outlet apparatus 10, as described above.

The remote control apparatus 130 may allow the timer settings and the switches to be engaged remotely from the power strip 110. For example, if the power strip is plugged into a wall socket (not shown), it may be difficult for a user to engage switches on the power strip 110 to operate the timer functions. Therefore, the remote control apparatus 130 may be placed at a more convenient location for easy access thereto.

The remote control apparatus 130 may include a bypass/engage switch 136, a rotary switch 140 for the selection of timed intervals, a momentary switch 142, and a bypass indicator 138 as well as an engaged indicator 144. The switches and indicators on the remote control apparatus 130 may operate identically to the respective switches described above with respect to the electrical outlet apparatus 10.

Specifically, the power strip 110 may allow a user to set a timer whereby electrical power may be completely disconnected from the plurality of electrical outlets 114 when the timer finishes its timed interval. The power strip 110 may also disconnect electrical power from the timer when the timer finishes its timed interval.

Therefore, neither a device plugged into one or more of the electrical outlets 114 nor the timer itself will draw power when not in use. The power strip 110 further may include bypass/engage switch 136. Specifically, the bypass/engage switch 136 may allow a user to either bypass the timer within the power strip 110 or engage the timer.

When the bypass/engage switch 136 is set, to “bypass”, a bypass indicator 138 may show that the bypass/engage switch 136 is set to bypass. Specifically, the bypass indicator 138 may preferably be a small light, such as a small LED that indicates the power strip 110 is set to bypass. Preferably, the LED may have a color, such as red, to demonstrate that the bypass/engage switch 136 may be set to bypass. Of course, any other indicator may be provided to demonstrate the bypass/engage switch is set to bypass.

Further, the power strip 110 may include rotary switch 140 (or multi-switch, or other like switch for selecting among options). Rotary switch 140 may allow a user of the power strip 110 to select a timed interval. When engaged and operational, the power strip 110 may provide power to the electrical outlets 114 for the duration of the timed interval set by the rotary switch 140. Although the timed interval may be selected by the rotary switch 140, as described herein, it should be noted that any other mechanism for selecting timed intervals may be utilized, as apparent to one having ordinary skill in the art.

The power strip 110 further may include momentary switch 142 for engaging the timer after the bypass/engage switch 136 is toggled to “engage” and after a timed interval is selected using the rotary switch 140. The momentary switch 142 may signal the timer to begin the countdown of the timed intervals by allowing the timer to be powered. Specifically, engaging the momentary switch 142 provides power to the timer within the power strip 110, as described in more detail below with reference to FIG. 3.

When the bypass/engage switch 136 is toggled to “engage” and after a user selects the timed interval via the rotary switch 140 and the momentary switch 142 may engage the timer, engage indicator 144 may show that the timer is engaged and operational, and actively counting down the selected time interval. Specifically, the engage indicator 144 may preferably be a small light, such as a small LED that indicates the bypass/engage switch is set to engage. Preferably, the LED may have a color, such as green, to demonstrate that the bypass/engage switch 136 may be set to engage, the timed interval may have been selected via the rotary switch 140, and the momentary switch 142 may have been engaged. Of course, any other indicator may be provided to demonstrate that the timer is engaged and supplying power to the electrical outlets 114.

When the bypass/engage switch 136 is set to engage, the timed interval is selected via the rotary switch 140, and the momentary switch 142 is engaged or otherwise pushed, electrical power flows freely through the electrical outlets 114, thereby supplying power to devices plugged into one or more of the electrical outlets 114. When the timed interval counts down to zero, the timer may completely disconnect AC power from the electrical outlets 114, thereby shutting off any devices plugged into the electrical outlets 114. Therefore, any “standby” power required by any device plugged into one of the electrical outlets 114 may not be provided, and the device plugged into one of the electrical outlets 114 may be completely devoid of power. In addition, the timer may further completely disconnected AC power from the timer itself. Therefore, the timer will draw no electrical power when not in use. Of course, when the bypass/engage switch 136 may be set to “bypass”, power may freely flow to the electrical outlets 114 to power any devices plugged thereinto.

Now referring to FIG. 3, a diagram of a preferred electrical circuit 210 of the present invention is disclosed. Specifically, the circuit 210 may include a bypass/engage switch 216, a rotary switch 220 (or multi-switch, or other switch for selecting among options, as apparent to one having ordinary skill in the art) and a momentary switch 222. The circuit may be plugged into or is otherwise connected to an AC power supply 212. Moreover, an electrical outlet 214 is illustrated. The electrical outlet 214 may supply power to devices plugged thereinto. Moreover, a plurality of electrical outlets may be provided, as described above with respect to FIGS. 1 and 2.

A red LED indicator 218 may be provided for indicating that the bypass/engage switch 216 may be set to “bypass”. Moreover, a green LED indicator 224 may be provided for indicating that the engage switch 216 may be set to “engage”, a timer interval may be set via the rotary switch 220, and the momentary switch 222 may be pushed or otherwise engaged to activate the timer.

The circuit 210, as illustrated in FIG. 3, may include a bypass circuit that may engage when the bypass/engage switch 216 may be switched to “bypass”, i.e., toggled left in FIG. 3, thereby bridging the AC power to the electrical outlet 214 and further completing the circuit to power the LED indicator 218. Specifically, a power supply 250 may be powered by the completion of the bypass circuit when the bypass/engage switch 216 may be toggled to complete the bypass circuit, thereby powering the LED indicator 218. Resistor R3 may be coupled with the LED indicator 218 to ensure proper functioning of the LED indicator 218. Preferably, resistor R3 may be a 4.7K-ohm resistor for the circuit 210, as illustrated in FIG. 3.

The power supply 250 may be any power supply useful for powering the components of the circuit 210. Preferably, the power supply 250 may be a 5V DC supply with 1 amp on DC output.

When bypass/engage switch 216 is toggled to “engage”, a timer circuit may be engaged. Specifically, the timer circuit may preferably be engaged when the bypass/engage switch 216 may be toggled to the right, according to the circuit 210, as shown in FIG. 3. When engaged, however, the timer circuit may not be powered until further activated via the momentary switch 222, which may complete the circuit to the power supply 250, which converts AC power to DC power to power the timer and the relay, as described below. This may allow setting of the rotary switch 220, which may allow a user to set various timer settings. The rotary switch 220 may be interconnected with an electronic timer 252, whereby different time intervals may be selected by the user. After the user selects the desired time interval via the rotary switch 220, the circuit may be powered by pressing the momentary switch 222, thereby completing the circuit to the power supply 250.

When the timer circuit is activated via pushing of the momentary switch 222, the timer 252 may be activated, thereby engaging a relay 254 that may complete a circuit between the AC power supply 212 and the electrical outlet 214 as well as to the power supply 250 and the timer 252. When the timer 252 expires, the relay may be disengaged, disconnecting the circuit between the AC power supply 212 and the electrical outlet 214. Therefore, when the timer 252 expires, the electrical outlet 214 may be completely disconnected from the AC power supply. In addition, when the relay is disengaged after the timer 252 expires, the power supply 250, and, hence, the timer 252 and the relay 254 may be completely disconnected from the AC power supply 212 as well. The power supply 250, the timer 252 and the relay 254 may then only be re-engaged upon resetting of the momentary switch 222 to supply power to the power supply 250 to engage the timer 252, thereby engaging the relay 254 and completing the circuit until the timer expires once again.

The electronic timer 252 may include a plurality of resistors R1 and R2, and capacitor C1 that may allow for proper functioning of the timer 252. Specifically, R1, R2 and C1 may be oscillator parts that set the base timing that may feed the digital counter of the timer 252, multiples of which may be used on the outputs of the timer 252 that may be selected by the rotary switch 220. It should be noted that any electronic timer may be utilized that may drive the relay 254, as apparent to one having ordinary skill in the art and the invention should not be limited as herein described and shown in FIG. 3.

When the timer circuit is engaged by setting the rotary switch 220 and pushing the momentary switch 222, the indicator LED 224, preferably green in color although any other indicator may be utilized as apparent to one having ordinary skill in the art, may indicate that the circuit is powered, thereby supplying power from the AC power supply 212 to the electrical outlet 214. When the timer expires, the power supply 250 and, hence, the timer 252 may be cut from the AC power supply 212, thereby not lighting the LED indicator 224, indicating to a user that the timer has expired and the electrical outlet 214 is no longer drawing AC power from the AC power supply 212. Resistor R4 may be coupled with the LED indicator 224 to ensure proper functioning of the LED indicator 224. Preferably, resistor R4 may be a 4.7K-ohm resistor for the circuit 210, as illustrated in FIG. 3, although any resistor may be utilized as apparent to one having ordinary skill in the art and the invention should not be limited as described herein and shown with respect to FIG. 3.

Although the indicators 218, 224 may be placed as shown and described with respect to FIG. 3, the indicators 218, 224 may be placed in any location apparent to one of ordinary skill in the art to demonstrate that the bypass circuit is engaged or that the timer circuit is engaged. Specifically, the LEDs may be driven by the AC power as opposed to the DC power supply 250. This may eliminate the need to turn on the power supply when the bypass circuit is selected via the switch 216. Moreover, indicator 224 may be placed after the relay, indicating that the timer circuit is engaged. By placing the indicator 224 after the relay, this may demonstrate that both the power supply and the relay are operational. As described above with respect to FIG. 3, the indicator 224 demonstrates that the power supply 250 is operational and will light whether the relay 254 is operational or not. By placing the indicator 224 after the relay, one may see whether both the power supply and the relay are operational or not.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. An electrical timer apparatus comprising:
a connector to engage AC power from an AC power source;
a female electrical receptacle for engaging a male electrical plug;
a timer circuit comprising a timer selector for selecting a timed interval and a momentary switch for completing the timer circuit, wherein the timer circuit provides electrical power to the female electrical receptacle and to the timer circuit when the momentary switch is engaged and further wherein the timer circuit disconnects electrical power from the female electrical receptacle and the timer circuit when the timed interval elapses;
a bypass circuit for providing electrical power to the female electrical receptacle when the bypass circuit is completed with the AC power; and
a switch to select either the timer circuit or the bypass circuit.

2. The electrical timer apparatus of claim 1 wherein the timer circuit comprises an electrical timer wherein the electrical timer provides the selectable timed interval.

3. The electrical timer apparatus of claim 1 wherein the timer circuit comprises a relay for allowing electrical power to flow to the female electrical receptacle and to the timer circuit when the timer circuit is selected via the switch, the timed interval is selected via the timer selector, and the momentary switch is engaged completing the timer circuit and further wherein the relay disconnects the electrical power from the female electrical receptacle and the timer circuit when the timed interval elapses.

4. The electrical timer apparatus of claim 1 wherein the timer circuit comprises an electrical timer wherein the electrical timer provides the selectable timed interval and further wherein the timer circuit comprises a relay for allowing electrical power to flow to the female electrical receptacle during the timed interval and further wherein the relay disconnects the electrical power from the female electrical receptacle and the timer circuit when the timer elapses.

5. The electrical timer apparatus of claim 1 wherein the timer selector comprises a plurality of selectable timed intervals.

6. The electrical timer apparatus of claim 1 wherein the connector to engage AC power from an AC power source is a male electrical plug to engage a female electrical receptacle.

7. The electrical timer apparatus of claim 1 further comprising a remote control apparatus wherein the switch, timer selector and momentary switch are operational remotely from the electrical timer switch apparatus.

8. The electrical timer apparatus of claim 1 further comprising:
an indicator showing when AC power flows to the female electrical receptacle.

9. The electrical timer apparatus of claim 1 further comprising:
an indicator showing when the bypass circuit is selected via the switch.

10. The electrical timer apparatus of claim 1 further comprising:
a DC power supply for powering the electrical timer circuit when the timer circuit is selected via the switch.

11. A system for disconnecting electrical power from an AC power source to a device requiring AC power for operation; the system comprising:
an AC power source;
a device requiring AC power;
an electrical timer apparatus comprising:
a connector to engage AC power from an AC power source;
a female electrical receptacle for engaging a male electrical plug;
a timer circuit comprising a timer selector for selecting a timed interval and a momentary switch for completing the timer circuit, wherein the timer circuit provides electrical power to the female electrical receptacle and to the timer circuit when the momentary switch is engaged and further wherein the timer circuit disconnects electrical power from the female electrical receptacle and the timer circuit when the timed interval elapses;
a bypass circuit for providing electrical power to the female electrical receptacle when the bypass circuit is completed with the AC power; and
a switch to select either the timer circuit or the bypass circuit,
wherein the device is plugged into the female electrical receptacle of the electrical timer apparatus and the electrical timer apparatus is connected to the AC power source.

12. The system of claim 11 wherein the timer circuit comprises an electrical timer wherein the electrical timer provides the selectable timed interval.

13. The system of claim 11 wherein the timer circuit comprises a relay for allowing electrical power to flow to the female electrical receptacle and to the timer circuit when the timer circuit is selected via the switch, the timed interval is selected via the timer selector, and the momentary switch is engaged completing the timer circuit and further wherein the relay disconnects the electrical power from the female electrical receptacle and the timer circuit when the timed interval elapses.

14. The system of claim 11 wherein the timer circuit comprises an electrical timer wherein the electrical timer provides the selectable timed interval and further wherein the timer circuit comprises a relay for allowing electrical power to flow to the female electrical receptacle during the timed interval and further wherein the relay disconnects the electrical power from the female electrical receptacle and the timer circuit when the timer elapses.

15. The system of claim 11 wherein the timer selector comprises a plurality of selectable timed intervals.

16. The system of claim 11 wherein the connector to engage AC power from an AC power source is a male electrical plug to engage a female electrical receptacle.

17. The system of claim 11 further comprising a remote control apparatus wherein the switch, timer selector and momentary switch are operational remotely from the electrical timer apparatus.

18. The system of claim 11 further comprising:
an indicator showing when AC power flows to the female electrical receptacle.

19. The system of claim 11 further comprising:
an indicator showing when the bypass circuit is selected via the switch.

20. The system of claim 11 further comprising:
a DC power supply for powering the electrical timer circuit when the timer circuit is selected via the switch.
